(19) United States
(12) Patent Application Publication
(10) Pub. No.: US 2025/0178831 A1
(43) Pub. Date: Jun. 5, 2025

(54) PET WASTE CONTAINER AND METHOD OF USE THEREOF

(71) Applicant: Towerstar Pets, LLC, Malvern, PA (US)

(72) Inventors: Fernando Becattini, JR., Malvern, PA (US); Jacquelyn N. Becattini, Malvern, PA (US); Fernando Becattini, Devon, PA (US)

(73) Assignee: Towerstar Pets, LLC, Malvern, PA (US)

(21) Appl. No.: 18/968,725

(22) Filed: Dec. 4, 2024

Related U.S. Application Data
(60) Provisional application No. 63/606,399, filed on Dec. 5, 2023.

(51) Int. Cl. B65F 1/00

(52) U.S. Cl. CPC B65F 1/0006; B65F 2240/136; B65F 2250/105; B65F 2250/108

(57) ABSTRACT

A pet waste bag or container is made from a biodegradable material. The pet waste bag can be donned by a pet owner inserting their hand into the bag to retrieve the pet waste. The bag may have a fluid resistant or impermeable layer on at least one surface of the bag. This layer precludes or substantially inhibits the waste from coming into physical contact with the pet owner's hand. The bag is configured to be inverted after the pet waste is retrieved and the bag may be sealed in some manner, such as through a twist. The bag containing the pet waste may then be discarded where it may naturally degrade in a landfill.

### CROSS REFERENCE TO RELATED APPLICATIONS

The present disclosure claims priority to and the benefit of U.S. Provisional Application Ser. No. 63/606,399, filed on Dec. 5, 2023, the entirety of which is incorporated herein by reference.

### TECHNICAL FIELD

This disclosure is directed at pet waste bags.

### BACKGROUND ART

Picking up pet waste or excrement has become a routine responsibility for pet owners, and one prevalent method involves using single plastic bags from a roll. While this approach provides a convenient solution for managing pet waste, particularly during walks or outdoor activities, there are notable drawbacks associated with plastic bags, primarily centered around environmental factors and the non-biodegradable nature of plastics.

Many pet owners rely on single-use plastic bags, often dispensed from a roll or purchased in bulk, to pick up and contain their pet's waste. These bags are lightweight, portable, and readily available, making them a popular choice for pet waste management. The bags are typically presented in a roll format and stored in dedicated dispensers that can be attached to a leash, belt, or carried in a pocket. This roll-and-tear design ensures that pet owners have a convenient and accessible solution for waste disposal while on the go. The pet owner will place their hand into the plastic bag, using the bag itself as a protective barrier, and pick up the pet waste from the ground. Then, the pet owner will invert the bag and throw away the pet waste.

One of the most significant drawbacks of plastic bags for pet waste management is their non-biodegradable nature. Traditional plastic materials can persist in the environment for hundreds of years, contributing to pollution and environmental degradation. This longevity poses a substantial threat to ecosystems, wildlife, and overall environmental health. Further, the disposal of plastic bags, even those used for pet waste, contributes to the burden on landfills. Due to their slow decomposition rate, plastic bags occupy valuable landfill space and contribute to the overall challenge of managing plastic waste.

Once disposed, as plastic bags break down over time, they degrade into smaller particles known as microplastics. These microplastics can infiltrate soil and water, posing a threat to aquatic life and potentially entering the food chain. The widespread use of plastic bags for pet waste exacerbates the issue of microplastic pollution in the environment. The generation of microplastics from pet waste bags poses a significant and detrimental impact on the environment, contributing to an alarming global issue.

Microplastics are tiny particles, usually measuring less than 5 millimeters in size, that result from the degradation of larger plastic items. In the context of pet waste bags, the breakdown of plastic materials over time leads to the release of microplastics, presenting several environmental concerns. When pet waste bags end up in landfills or open environments, they are susceptible to weathering and breaking down into smaller particles. These microplastics can then be washed away by rain or other environmental factors, finding their way into water bodies. In aquatic environments, microplastics pose a direct threat to aquatic life. Microplastics, once introduced into water bodies, can be ingested by marine organisms. From plankton to fish and larger marine animals, the ingestion of microplastics can have severe consequences, impacting their health and potentially entering the food chain. This poses a threat not only to individual organisms but to entire aquatic ecosystems.

Microplastics can accumulate in sediments, affecting the environment and the organisms that inhabit these areas. The persistence of microplastics in sediments can lead to long-term environmental consequences, disrupting the balance of marine ecosystems and affecting sediment-dwelling organisms.

In terrestrial environments, microplastics derived from pet waste bags can contaminate soils. As these particles break down further, they may infiltrate the soil, potentially altering its structure and composition. This soil pollution can have implications for plant growth and other organisms within the ecosystem.

Wildlife, both aquatic and terrestrial, may inadvertently ingest microplastics when they mistake these particles for food. The ingestion of microplastics can lead to internal injuries, digestive issues, and bioaccumulation of toxins, posing a threat to the health and survival of various species.

The introduction of microplastics from pet waste bags can contribute to ecological disruption. The interconnectedness of ecosystems means that the effects of microplastic pollution can cascade through food webs, affecting not only individual organisms but entire ecological communities. As microplastics enter aquatic ecosystems and potentially move up the food chain, there are concerns about the indirect impact on human health. Seafood consumption, in particular, may become a route of exposure to microplastics and associated contaminants.

Additionally, there are practical reasons for eliminating the usage of single-use plastic bags. Many municipalities are legislating to eliminate the usage of single-use plastic bags. For example, there are a plethora of local legislations that require retailers to stop providing single-use plastic bags. These legislations are part of a broader effort to reduce the environmental impact of single-use plastics. They aim to cut off the flow of plastics into public life and into the environment.

### SUMMARY OF THE INVENTION

In light of these environmental concerns and the legislation to eliminate single-use plastic bags, there is a growing recognition of the need to address the issue of plastic pollution, not only from larger plastic items but also from seemingly innocuous sources like pet waste bags. Sustainable alternatives that prioritize biodegradability and minimize the environmental impact of waste disposal are needed for mitigating the proliferation of microplastics in the environment and safeguarding ecosystems and human health.

While current techniques involving plastic bags provide a practical solution for pet waste management, the environmental and legislative drawbacks associated with plastics underscore the need for more sustainable alternatives. The detrimental impact of plastic pollution on ecosystems and the broader environment necessitates a transition towards eco-friendly options that prioritize the well-being of the planet. As awareness grows, pet owners are increasingly seeking responsible and sustainable solutions to minimize their environmental footprint in managing their pets' waste. The present disclosure addresses these and other issues by providing a pet waste bag made from more sustainable sources while still maintaining the ease of use that pet owners have come to recognize.

In one aspect, an exemplary embodiment of the present disclosure may provide a disposable pet waste container comprising: a bag body formed of paper, the bag body having a first side opposite a second side, and an open top opposite an enclosed bottom; an exterior surface of the bag body and an interior surface of the bag body, wherein the interior surface defines a volume sized to accommodate a pet owner's hand through the open top; a wax layer applied only to the exterior surface and not to the interior surface; wherein the bag body is configured to be inverted in response to the pet owner's grasping of pet waste with the bag body, wherein the wax layer and bag body forms a protective barrier and the wax layer directly contacts the pet waste during grasp of pet waste and, wherein after inversion the wax layer is on the inside of the inverted bag. This exemplary embodiment may provide that the first side of the bag body has a gusset. This exemplary embodiment may provide that the second side of the bag body has a gusset. This exemplary embodiment may provide that the enclosed bottom of the bag body has a gusset. This exemplary embodiment may provide that the first side of the bag body has a first gusset, the second side of the bag body as a second gusset, and the enclosed bottom of the bag body as a third gusset.

In yet another aspect, an exemplary embodiment of the present disclosure may provide a disposable pet waste container comprising: a bag body formed of paper, the bag body having a first side opposite a second side, and an open top opposite an enclosed bottom; an exterior surface of the bag body and an interior surface of the bag body, wherein the interior surface defines a volume sized to accommodate a pet owner hand through the open top; and a protective barrier on the exterior surface of the bag body; wherein the bag body is configured to be inverted in response to the pet owner grasping pet waste with the bag body, wherein the protective barrier directly contacts the pet waste during grasping of pet waste, wherein after inversion the protective barrier is on the inside of the inverted bag. This exemplary embodiment or another exemplary embodiment may further provide that the protective barrier is applied only to the exterior surface and not to the interior surface prior to inversion. This exemplary embodiment or another exemplary embodiment may further provide that the protective barrier is formed from wax and defines a wax layer on the exterior surface of the bag body. This exemplary embodiment or another exemplary embodiment may further provide that the wax is biodegradable and only on the exterior surface of the bag body and not to the interior surface prior to inversion. This exemplary embodiment or another exemplary embodiment may further provide that the first side of the bag body has a gusset. This exemplary embodiment or another exemplary embodiment may further provide that the second side of the bag body has a gusset. This exemplary embodiment or another exemplary embodiment may further provide that the enclosed bottom of the bag body has a gusset. This exemplary embodiment or another exemplary embodiment may further provide that the first side of the bag body has a first gusset, the second side of the bag body as a second gusset, and the enclosed bottom of the bag body as a third gusset. This exemplary embodiment or another exemplary embodiment may further provide that the bag body is formed of distressed paper. This exemplary embodiment or another exemplary embodiment may further provide that the bag body is formed from kraft paper. This exemplary embodiment or another exemplary embodiment may further provide that the open top is wider than the enclosed bottom. This exemplary embodiment or another exemplary embodiment may further provide that the first side and the second side of the bag body taper from the open top to the enclosed bottom. This exemplary embodiment or another exemplary embodiment may further provide that the bag body further comprises a top edge defining a portion of the open top of the bag body, wherein the top edge has a first end connected to the first side of the bag body and a second end connected to the second side of the bag body, wherein the top edge is curved between the first end and the second end. This exemplary embodiment or another exemplary embodiment may further provide that the bag body further comprises an apex in the top edge that is curved, wherein the apex is centered relative to a width of the bag body. This exemplary embodiment or another exemplary embodiment may further provide that the bag body further comprises a radius of curvature of the top edge that is curved, wherein the radius of curvature is in a range from about 3 inches to about 6 inches. This exemplary embodiment or another exemplary embodiment may further provide that the radius of curvature is 4.5 inches. This exemplary embodiment or another exemplary embodiment may further provide that the bag body further comprises a minor first curvature at the first end of the top edge, wherein the minor first curvature is curved oppositely than the top edge; and a minor second curvature at the second end of the top edge, wherein the minor second curvature is curved oppositely than the top edge. This exemplary embodiment or another exemplary embodiment may further provide that the top edge is convexly curved, and wherein the minor first curvature and the minor second curvature are concavely curved. This exemplary embodiment or another exemplary embodiment may further provide that the bag body further comprises: a radius of curvature of a central major portion the top edge (R1); a radius of curvature of the minor first curvature at the first end (R2); a ratio of R1 to R2, wherein the ratio is in a range from about 4:1 to about 12:1. This exemplary embodiment or another exemplary embodiment may further provide that R1 is 4 inches and R2 is ⅝ inch, and the ratio of R1 to R2 is 4:0.625.

In yet another aspect, an exemplary embodiment of the present disclosure may provide a method comprising: donning a disposable pet waste container by reaching through an open top towards an enclosed bottom of a bag body formed of paper, and the bag body having an exterior surface coated with a wax; approaching pet waste with the donned disposable pet waste container; contacting the wax with the pet waste; grasping the pet waste; picking up the pet waste while continuing to grasp the pet waste; inverting the disposable pet waste container while continuing to grasp the pet waste; doffing the disposable pet waste container after inversion to retain the pet waste in a now-reversed interior of the bag body; and disposing the bag body containing the pet waste. This exemplary embodiment or another exemplary embodiment may further include, after doffing, twist closing the open top of the bag body. This exemplary embodiment or another exemplary embodiment may further include inverting the disposable pet waste container while continuing to grasp the pet waste is accomplished by grasping a top edge of the bag body with an opposite hand than that which is grasping the pet waste. This exemplary embodiment or another exemplary embodiment may further include pulling the top edge of the bag body toward the enclosed bottom of the bag body where the pet waste is grasped. This exemplary embodiment or another exemplary embodiment may further include pulling the top edge from an apex of the top edge of the bag body, wherein the top edge is convexly curved. This exemplary embodiment or another exemplary embodiment may further provide that donning the disposable pet waste container comprises reaching though the open top and beyond a top edge of the bag body that is convexly curved. This exemplary embodiment or another exemplary embodiment may further provide that donning the disposable pet waste container comprises expanding a first side gusset of the bag body in response to reaching through the open top. This exemplary embodiment or another exemplary embodiment may further provide that donning the disposable pet waste container further comprises expanding a second side gusset of the bag body in response to reaching through the open top. This exemplary embodiment or another exemplary embodiment may further provide that donning the disposable pet waste container comprises expanding a bottom gusset defining the enclosed bottom of the bag body in response to reaching through the open top. pulling the top edge of the bag body toward the enclosed bottom of the bag body where the pet waste is grasped. This exemplary embodiment or another exemplary embodiment may further provide pulling from an apex of the top edge of the bag body, wherein the top edge is curved. This exemplary embodiment or another exemplary embodiment may further provide pulling the top edge of the bag body, wherein the top edge is curved; and passing the top edge by an upwardly extending ear defined in a side panel of the bag body as the top edge is pulled toward the bottom enclosed bottom. This exemplary embodiment or another exemplary embodiment may further provide bending a first minor curvature located at a first end of the top edge and bending a second minor curvature located at a second end of the top edge in response to pulling the top edge. This exemplary embodiment or another exemplary embodiment may further provide that donning the disposable pet waste container comprises reaching though the open top and beyond a top edge of the bag body, wherein the top edge is curved at a central major portion of the top edge. This exemplary embodiment or another exemplary embodiment may further provide that donning the disposable pet waste container further comprises reaching though the open top and beyond a first minor curvature located at a first end of the top edge and beyond a second minor curvature located at a second end of the top edge, wherein the first minor curvature and the second minor curvature are oppositely curved than the central major portion of the top edge.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is diagrammatic view of a pet owner walking their pet.

FIG. 2 is a top isometric view of one exemplary pet waste container embodied as a bag.

FIG. 3 is a bottom plan view of the pet waste bag.

FIG. 4 is a side elevation view of the pet waste bag.

FIG. 5 is a cross section view taken alone line 5-5 in FIG. 2 depicting that there is a protective barrier layer on only the exterior surface of the bag body and the interior surface of the bag body is uncoated.

FIG. 6A is an operational view of the pet owner placing their hand into the pet waste bag and approaching pet waste to be picked up.

FIG. 6B is an operational view of the pet owner picking up the pet waste and starting to invert the pet waste bag.

FIG. 6C is a side elevation view of the pet waste bag after inversion and containing the pet waste therein, and closed with a twist-knot closure.

FIG. 7 is a front elevation view of another embodiment of a pet waste bag having gusseted sides and a non-gusseted bottom.

FIG. 8 is a front elevation view of another embodiment of a pet waste bag having tapered gusseted sides and a non-gusseted bottom.

FIG. 9A is a front elevation view of another embodiment of a pet waste bag having a curved top edge and a non-gusseted bottom.

FIG. 9B is a top, front perspective view of the pet waste bag from FIG. 9A.

FIG. 10A is a front elevation view of another embodiment of a pet waste bag having a curved top edge with curved lower ends, and a non-gusseted bottom.

FIG. 10B is a top, front perspective view of the pet waste bag from FIG. 10A.

FIG. 11A is front elevation view of another embodiment of a pet waste bag having tapered gusseted sides and a gusseted bottom.

FIG. 11B is a top, front perspective view of the pet waste bag from FIG. 11A.

Similar numbers refer to similar parts throughout the drawings.

### DETAILED DESCRIPTION

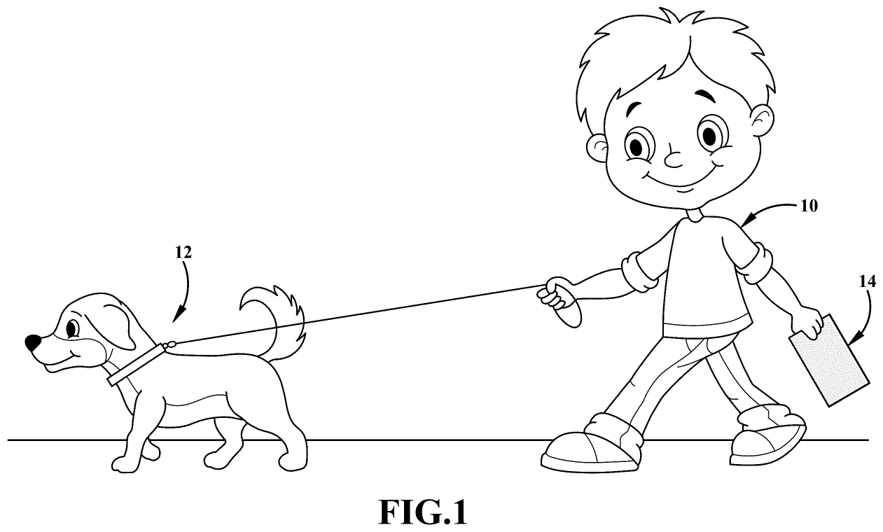

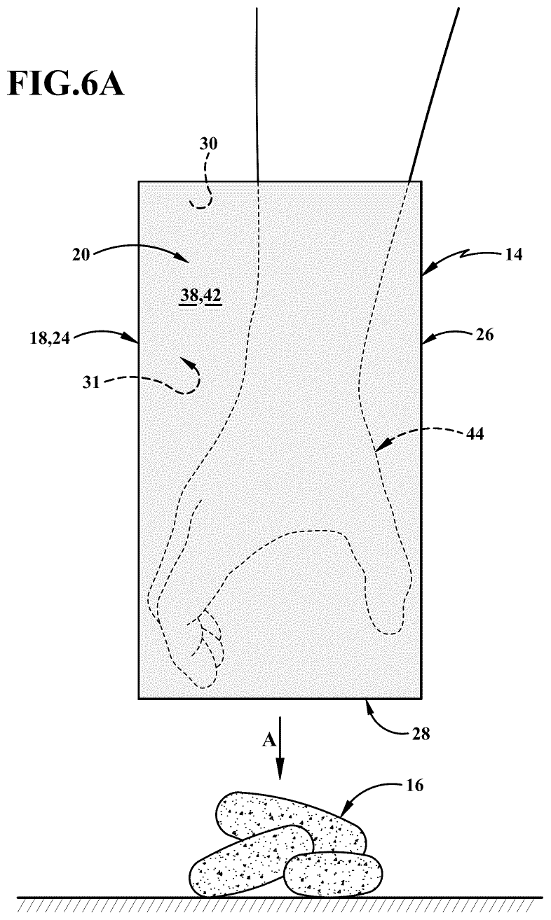

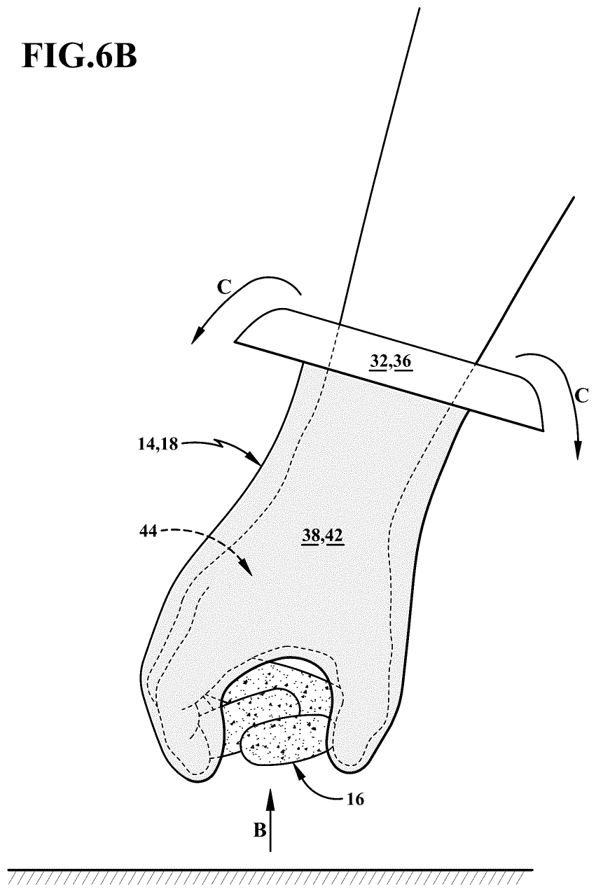

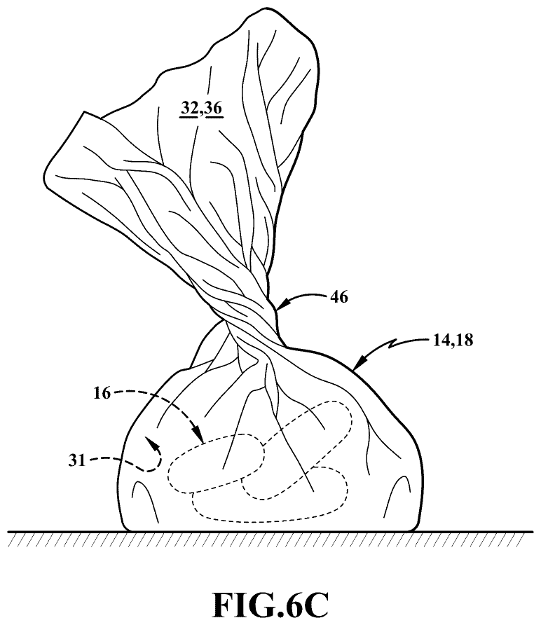

FIG. 1 depicts a pet owner 10 and a pet 12. In one example the pet 12 is a dog, however as described herein the pet 12 could be another animal, mammal, reptile, amphibian, bird or fish. The pet owner 10 may carry a pet waste container 14 that is configured to assist the pet owner 10 with picking up pet waste or excrement 16 (see FIG. 6A-6C). The entirety of the container 14 should be biodegradable after picking up the pet waste 16. Pet waste container 14 may also be referred to herein as pet waste bag 14, or simply bag 14. The present disclosure details different embodiments of various pet waste bags, each having a slightly different configuration, but each being able to effectuate the picking up of pet waste 16 and being biodegradable after disposal.

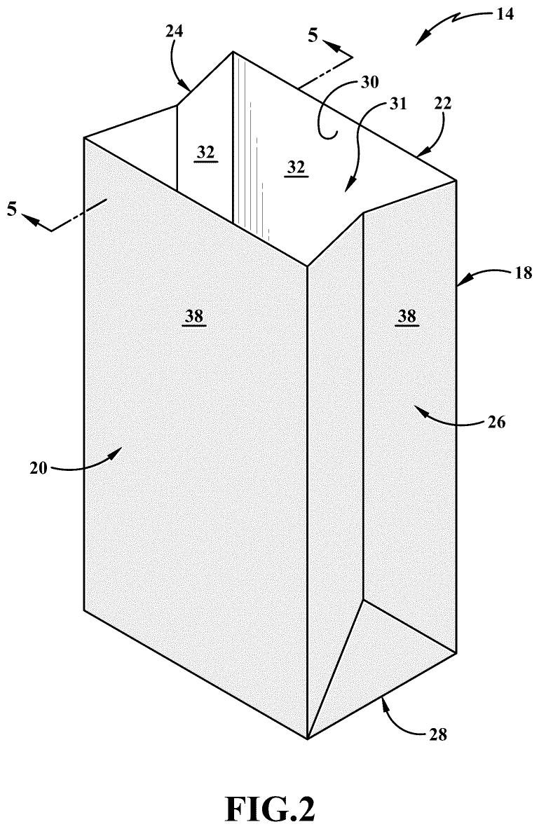

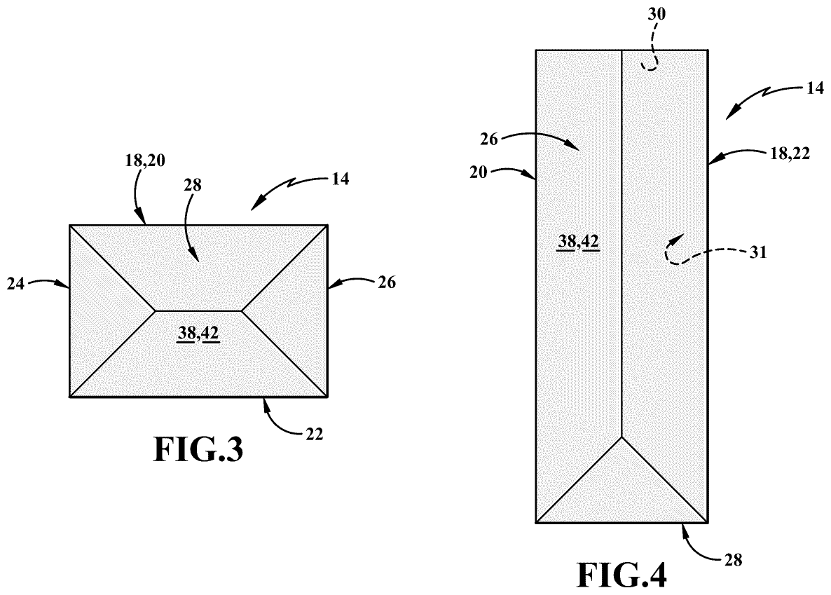

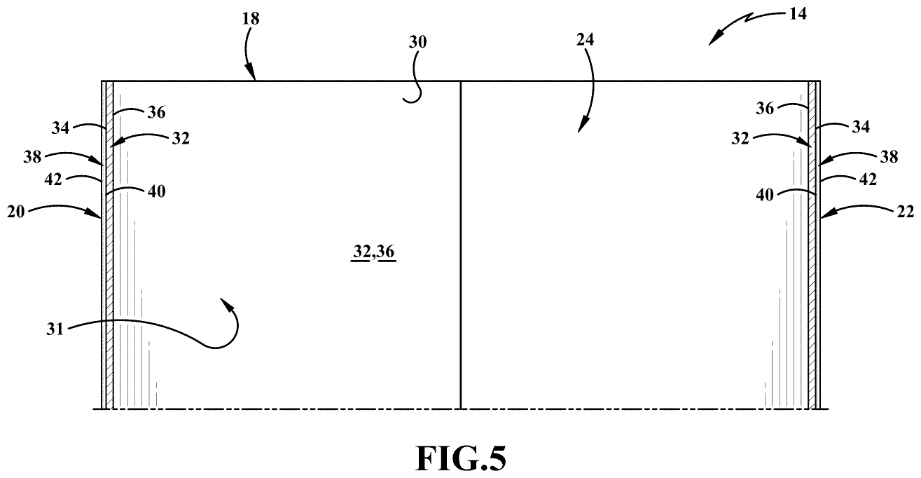

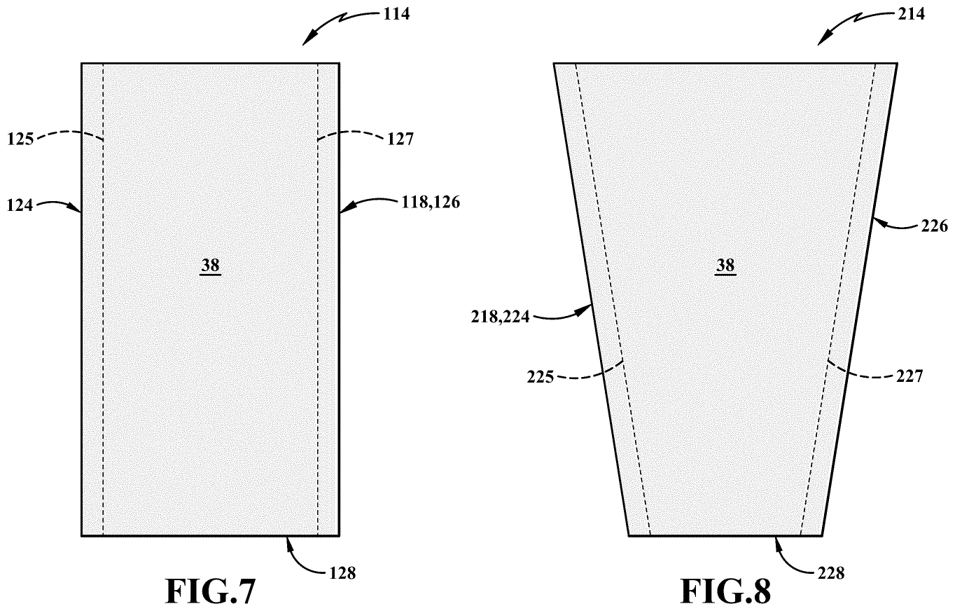

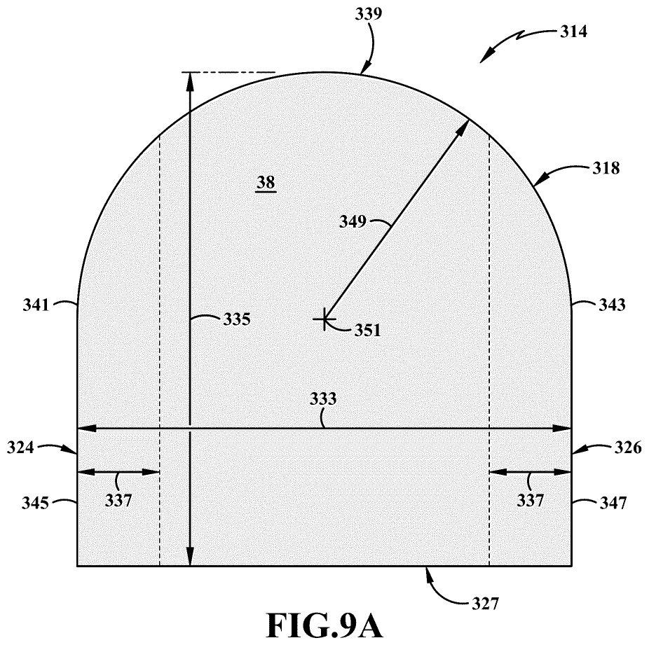

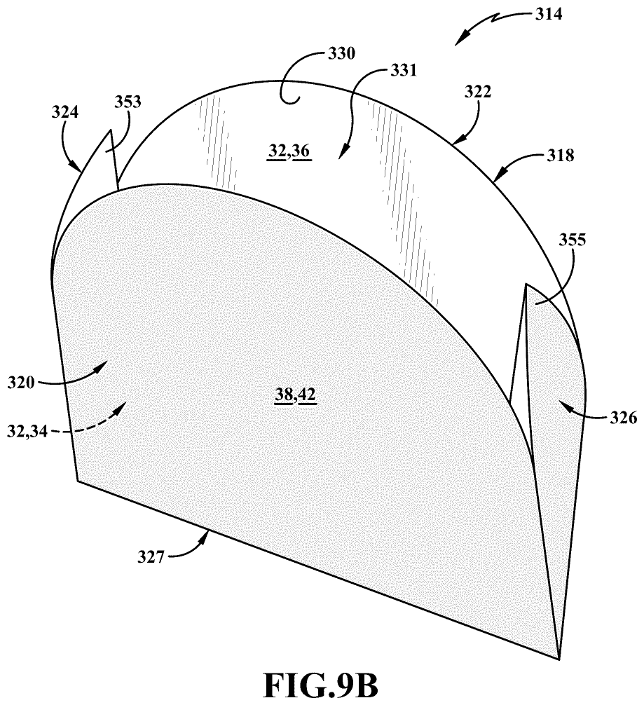

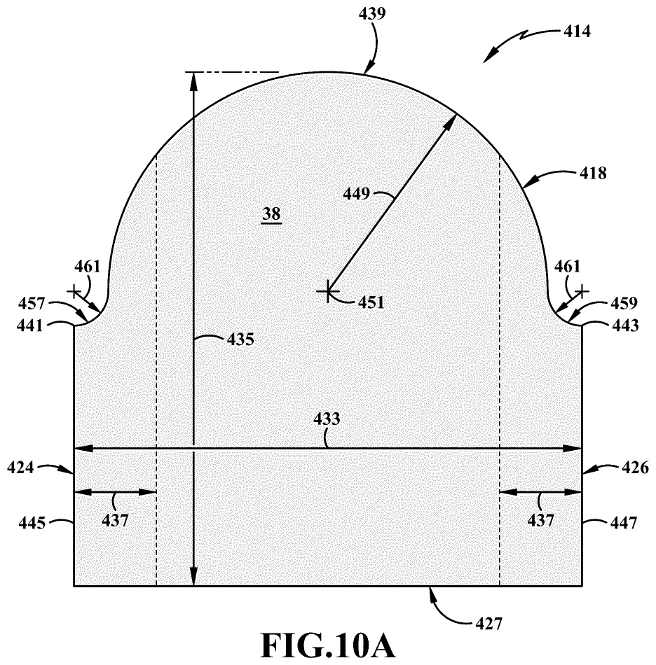

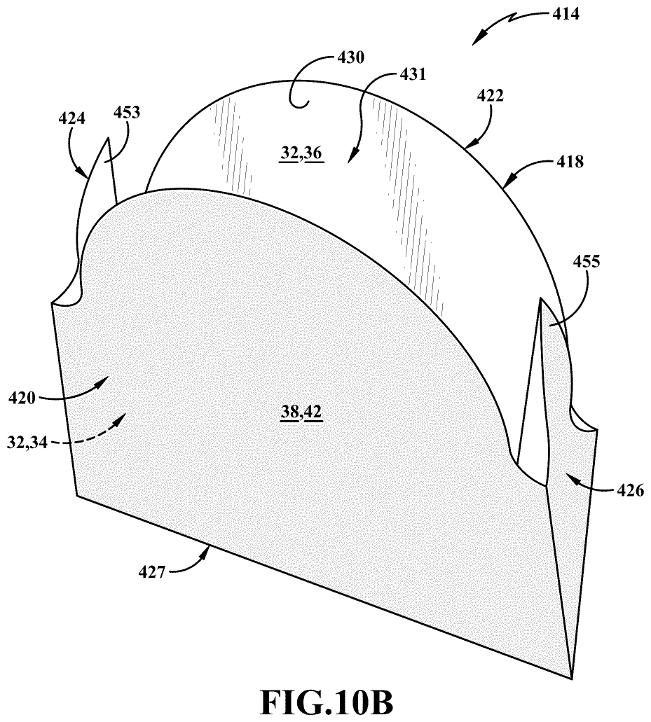

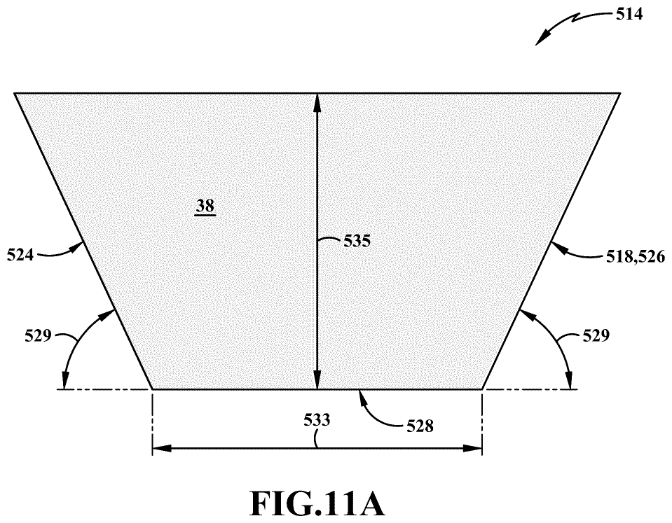

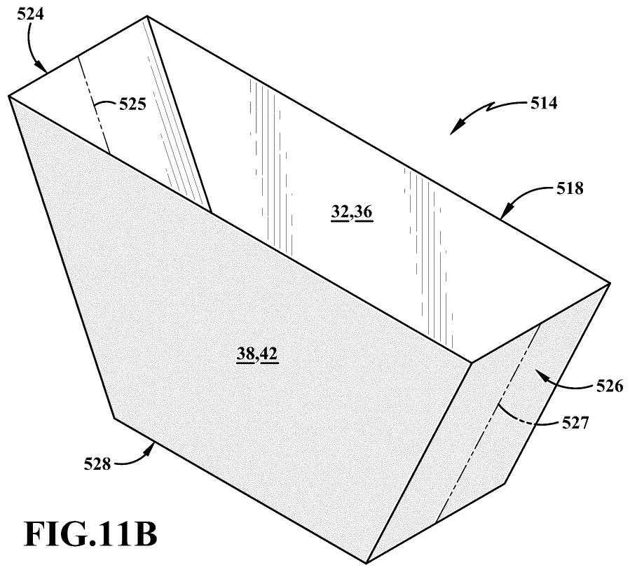

For example, FIG. 2-FIG. 5 depict one embodiment of a pet waste bag as bag 14. FIG. 7 depicts another exemplary pet waste bag or pet waste container 114. FIG. 8 depicts another exemplary embodiment of a pet waste bag or pet waste container 214. FIGS. 9A-9B depict another exemplary embodiment of a pet waste bag or pet waste container 314. FIGS. 10A-10B depict another exemplary embodiment of a pet waste bag or pet waste container 414. FIGS. 11A-11B depict another exemplary embodiment of a pet waste bag or pet waste container 514. Any of these bags could be used in the manner or method of operation detailed in FIGS. 6A-6C. Thus, while FIGS. 6A-6C are primarily described with respect to bag 14, it is to be understood that the method similarly applies to the other embodied pet waste bags.

FIG. 2-FIG. 5 depict that the pet waste bag 14 may be shaped as a bag. When the bag 14 is shaped like a bag, there is a bag body 18 which may have a first panel 20 and a second panel 22. There may be a first side panel 24, a second side panel 26, and a bottom panel 28. The bag body 18 defines a top opening 30 and has an enclosed bottom end because of bottom panel 28. As will be detailed herein, at least one of the first side panel 24, the second side panel 26, and the bottom panel 28 may or could be gusseted, although it is not necessarily required.

Incorporating either gusseted sidewalls (e.g. first side panel 24 or second side panel 26), a gusseted bottom (e.g., bottom panel 28), or both into a paper pet waste bag body 18 coated with a protective barrier 38 on the exterior surface can enhance the bag's functionality, especially during the inversion process, which is described in greater detail herein. These design features provide added flexibility, strength, and convenience, making it easier for pet owners to manage and invert the bag after picking up their pet's waste.

One embodiment of the present disclosure depicts the bag 14 with both gusseted sidewalls (e.g. first side panel 24 or second side panel 26) and a gusseted bottom (e.g., bottom panel 28). However, another embodiment of the present disclosure depicts the carrier with gusseted sidewalls (e.g. first side panel 24 or second side panel 26) and a non-gusseted bottom edge (see FIG. 7 and FIG. 8). Additionally, while not shown in the Figures, it is possible to have another embodiment that has non-gusseted sidewalls and a gusseted bottom edge.

The term “gusset” or “gusseted” refer to additional folds or pleats on the sides or bottom of the bag body 18 that expand when the bag is filled. In the context of the pet waste bag, gusseted sidewalls contribute to increased volume and depth, providing more space for waste without compromising the bag's structural integrity. When the pet owner picks up the waste 16 and inverts the bag, the gusseted sidewalls accommodate the volume of the waste 16 more effectively. This design minimizes the risk of tearing or rupturing, ensuring that the bag remains intact during and after the inversion process. The additional space created by gusseted sidewalls also allows for easier closure and twist tying.

A gusseted bottom panel 28 includes folds or pleats at the base of the bag, creating a broader and more stable foundation. In the context of the pet waste bag 14, a gusseted bottom provides a wider surface area, enhancing the bag's stability when placed on the ground for waste collection. When it comes time to invert the bag, the gusseted bottom ensures that the bag remains open and has an expanded position, facilitating a smoother and more controlled inversion process. This feature is particularly valuable when dealing with varying amounts or types of pet waste, which depends on the size of the pet.

Utilizing gusseted sidewalls and/or a gusseted bottom synergistically enhances the overall design of the pet waste bag 14. The combined effect provides not only increased volume but also ease of use during waste collection and inversion. The gusseted bottom ensures the bag maintains its shape, while the gusseted sidewalls contribute to the bag's flexibility and capacity.

Further, although the figures show a single crease or edge defining the gusset on each side or bottom, it is possible for there to be multiple gusseted walls. This would result in a bag with an accordion or concertina shape, where the sides of the bag can expand and contract, based on multiple folds. This design would also provide flexibility in adjusting the bag size based on the amount of waste being collected.

The size parameters of an exemplary pet waste bag depend on various factors, including the intended use, the size of the pets, and user preferences. In one exemplary embodiment, the pet waste bag 14 should be of sufficient size to comfortably accommodate the waste 16 produced by different sizes of pets 12. Common dimensions for a pet waste bag body 18, when laid flat, have a width (side-to-side) that is in a range from about 6 inches to about 18 inches, and a length (top-to-bottom) that is in a range from about 6 inches to about 24 inches. In one exemplary embodiment, the dimensions of the bag, when laid flat, are approximately 9 inches wide by 15 inches long. This should provide enough space for waste collection without being overly large or cumbersome.

The preferred volume defined by the interior space 31 that is in open communication with the top opening 30 of a pet waste bag is advantageous to ensure ease of use and practicality during the inversion process. A well-designed bag should offer sufficient volume, defined by interior space 31, to accommodate various amounts of pet waste while also providing an opening large enough for the user's hand to perform the inversion comfortably. A suitable volume defined by interior space 31 allows for the effective containment of pet waste, catering to the variability in waste quantities produced by different pets. Generally, the pet waste bag with a volume ranging from 0.5 to 4.5 liters is considered practical for everyday use. For example, the bag should be sized to accommodate the amount of waste that the pet produces. For example, it is common for large dogs to produce large amounts of excrement, and the size or volume of the bag should account for that amount of waste. However, the bag could be manufactured in a smaller size if configured for use with a smaller dog or other pet.

As stated previously, some embodiments of the present disclosure have gussets that allow the bag to expand and provide additional volume, making it more versatile for various waste quantities. A typical gusset depth might range from 2 to 4 inches, allowing the bag to expand when needed while maintaining strength and tear resistance. The depth of the gusseted bottom can be similar to that of the gusseted side panels 24, 26.

The pet waste bags of the present disclosure may be provided in a folded form for convenient dispensing. The size bag when in this compact folded state should be practical for easy storage and dispensing. It is likely that the bag 14 will be provided in a folded configuration when the bag 14 is made from paper so that the user can unfold the bag 14 for deployment and usage. In a commercial context, the folded bag 14 would be sold and provided with a plurality of other identically configured bags 14 that the user will be able to extract from a larger package one-at-a-time, usually when their pet is ready for a walk. Although the folded configuration of the bag 14 is most likely, the bag 14 could also be provided to the user in a rolled configuration. If provided in a rolled configuration roll, then the size parameters should also ensure that the bags are easily dispensed. Further alternatively, the pet waste bags of the present disclosure may be provided in a flat configuration defining a stack of a plurality of similarly structured distinct bags.

The top opening 30 of the bag should be designed to accommodate the user's hand comfortably during the inversion process. A typical dimension for the top opening is around 6 to 18 inches (about 15 to 45 centimeters) in width. This width ensures that users can easily reach into the bag to pick up pet waste without struggling with a narrow or restrictive opening. The dimensions of the top opening 30 should prioritize user comfort and dexterity. A wider opening allows for easy access, making it simpler for users to perform the inversion process and twist knots securely after collecting pet waste. The design should be intuitive, ensuring a seamless experience for pet owners 10 of all ages. For pet owners 10 with larger breeds that produce more substantial waste 16, a slightly larger volume and larger top opening may be beneficial. This ensures that the bag remains practical and effective for users with pets of varying sizes.

The bag's dimensions, volume and shape should contribute to the overall ease of the inversion process. Users should be able to turn the bag inside out effortlessly (e.g., invert), allowing for quick and efficient disposal of pet waste. The design should minimize any resistance or difficulty in performing this task.

The bag body 18 may be composed of at least one layer of paper material 32 that defines each of the panels 20, 22, 24, 26, and 28. When the bag is in its normal position (i.e., not inverted), the paper material 32 has an exterior surface 34 and an interior surface 36 that defines the interior space 31 or volume of the bag body 18.

The type of paper material 32 commonly used to form bags, similar to paper grocery bags or paper lunch bags, is typically referred to as kraft paper. Kraft paper is a sturdy and versatile material that is well-suited for various packaging applications, including bags for carrying items such as, according to embodiments of the present disclosure, pet waste or pet excrement 16. Kraft paper may be made from the pulp of softwood trees, typically pine and spruce. The kraft pulping process involves treating wood fibers with chemicals to break down lignin, which strengthens the resulting paper. One of the defining features of kraft paper is its strength. It has good tear resistance and can withstand heavy loads. This durability makes it well-suited for carrying pet excrement 16 without easily tearing or breaking. Kraft paper is highly versatile and can be easily folded, creased, and molded into various shapes, making it ideal for bag-making processes. It provides a good surface for printing or labeling, allowing for customization.

The strength characteristics of kraft paper make it a reliable choice for pet waste bags, such as pet waste container 14. While the specific strength can vary based on factors such as the paper's weight and thickness, there are some general features of the strength characteristics of kraft paper used as a pet waste bag.

Tensile strength measures the paper's resistance to a force pulling it apart. Kraft paper is known for its high tensile strength, and pet waste bags made from this material can withstand considerable pulling forces without tearing. This strength is advantageous when pet owners pick up waste, ensuring the bag remains intact during use.

Kraft paper has sufficient tear resistance, making it durable and less prone to tearing when subjected to stress or puncture. This characteristic is particularly valuable in pet waste bags, where tears could result in leakage and compromise the bag's functionality.

Burst strength measures a material's ability to withstand pressure or weight. Kraft paper used for pet waste bags typically has good burst strength, allowing it to hold pet waste securely without rupturing, especially when the bag is subject to pressure during handling or disposal.

Kraft paper exhibits sufficient fold endurance, meaning it can be folded and creased without weakening or losing its structural integrity. This characteristic is advantageous for the practicality of pet waste bags, as users often fold and manipulate the bags during waste collection and disposal.

The coefficient of friction determines the ease with which one surface can slide over another. In the context of pet waste bags, a balanced coefficient of friction ensures that the bags can be easily separated from a stack or roll (which could have perforated ends or simply be rolled together) without sticking together. This is advantageous for convenient and efficient bag dispensing.

While kraft paper is not naturally waterproof, it does exhibit reasonable wet strength. When coated with wax or other moisture-resistant materials, the wet strength of kraft paper is enhanced. This is advantageous for pet waste bags, as they may come into contact with moisture during use for picking up pet waste.

The specific strength characteristics of kraft paper that form the pet waste bag of the present disclosure can vary based on factors such as the paper's weight (measured in pounds per ream or grams per square meter) and thickness. Manufacturers may produce different grades of kraft paper to meet specific strength requirements for various applications, including those related to pet waste management. Thus, one exemplary embodiment provides a pet waste bags made from kraft paper that is designed to offer a balance of strength, durability, and environmental friendliness for responsible waste disposal.

The strength characteristics of a paper bag can be influenced by various factors, with the thickness of the paper. In one example, consider that the pet waste container 14 could have a paper thickness that is in a range from about 40 to about 80 grams per square meter (gsm). These could have some of the following general strength data associated with paper bags within this range.

With respect to tensile strength, a 40 gsm paper could have tensile strength of approximately 1 to 15 N (Newtons) per 15 mm width (approximately 0.0059 N/m); a 50 gsm paper could have tensile strength of approximately 1 to 20 N per 15 mm width (approximately 0.0074 N/m); a 60 gsm paper could have a tensile strength of approximately 5 to 25 N per 15 mm width (approximately 0.0088 N/m); a 70 gsm paper could have a tensile strength of approximately 1 to 30 N per 15 mm width (approximately 0.0103 N/m); and a 80 gsm paper could have tensile strength of approximately 1 to 35 N per 15 mm width (approximately 0.0118 N/m).

With respect to burst strength, which measures a material's ability to withstand pressure or weight, a 400 gsm paper could have a burst strength of approximately 50 to 200 kPa (Kilopascals); a 50 gsm paper could have a burst strength of approximately 50 to 250 kPa; a 60 gsm paper could have a burst strength of approximately 50 to 300 kPa; a 70 gsm paper could have a burst strength of approximately 50 to 50 kPa; and a 80 gsm paper could have a burst strength of approximately 50 to 400 kPa.

With respect to tear resistance, a 40 gsm paper could have a tear resistance of approximately 0.5 to 4 N (Elmendorf tear test); a 50 gsm paper could have a tear resistance of approximately 0.5 to 6 N (Elmendorf tear test); a 60 gsm paper could have a tear resistance of approximately 0.5 to 8 N (Elmendorf tear test); a 70 gsm paper could have a tear resistance of approximately 0.5 to 10 N; a 80 gsm paper could have a tear resistance of approximately 0.5 to 12 N.

With respect to fold endurance, which measures how well the paper maintains its strength after repeated folding, a 40 gsm paper could have a fold endurance of approximately 100 to 500 folds (MIT folding endurance test); a 50 gsm paper could have a fold endurance of approximately 150 to 600 folds; a 60 gsm paper could have a fold endurance of approximately 150 to 700 folds; a 70 gsm paper could have a fold endurance of approximately 200 to 700 folds; a 80 gsm paper could have a fold endurance of approximately 200 to 800 folds.

Notably, these strength data are general estimates and can vary based on specific paper compositions and manufacturing processes. Additionally, the practical strength of the paper bag is influenced by factors such as its design, construction, and intended use. Manufacturers may adjust these parameters to meet specific requirements for the retrieval of pet waste 16.

Kraft paper is naturally brown in color. This hue is a result of the pulping process, which retains more of the wood's natural color. The brown color is a characteristic feature of many paper grocery bags and lunch bags. However, if desired, the pet waste bag of the present disclosure may be colored or dyed to be any color to meet the application specific needs of the present disclosure. Further, manufacture indicia or logos can be applied or printed on the bag body 18.

Kraft paper is biodegradable and environmentally friendly. It breaks down naturally over time, making it a sustainable choice for single-use applications like the pet waste bag or bag 14 of the present disclosure so as to eliminate environmental impacts of conventional pet waste bags composed of microplastics. Thus, using kraft paper as the bag of the present disclosure aligns with the growing emphasis on reducing environmental impact. Further, kraft paper is readily recyclable. Many recycling facilities accept kraft paper, making it a material that can be easily integrated into recycling streams to further minimize its environmental footprint. This would be beneficial if unused bags are being recycled.

Kraft paper is compatible with wax coating. The kraft paper provides a suitable surface for adhering the protective wax layer. The wax-coated exterior enhances the bag's resistance to moisture, making it suitable for applications like pet waste bags. Given these characteristics, kraft paper strikes a balance between strength, eco-friendliness, and versatility, making it a suitable choice for the production of bags that are environmentally conscious for pet waste management.

Although the bag 14 having bag body 18 has been described with reference to kraft paper. Other types of paper could be used to form bag body 18. For example, the bag body could be made from recycled paper, newsprint paper, cardstock or cardboard paper, bleached white paper, linen paper, or bamboo paper. Still further, other types of biodegradable materials could be used to form the bag body 18. For example, the bag body could be made from cornstarch-based materials, bagasse, cotton canvas, hemp fiber, jute, mushroom mycelium, algae-based materials.

Further, in one exemplary embodiment, the bag body 18 can be distressed by the manufacture of the bag before providing the bag 14 to the pet owner. Distressing the surface of a paper bag body 18 may include intentionally created small imperfections, wrinkles, or creases in the paper form the body 18. This process or these distressed features can help soften the texture of the bag body without compromising its strength. The introduction of subtle irregularities in the paper's surface, may make it more pliable and easier to manipulate during the inversion process. As a result, the paper becomes less rigid and more responsive to handling, making it easier for users to manipulate during the inversion step without encountering stiffness or resistance. Further, the distressed surface may provide a tactile quality, making it easier for pet owners to hold onto the bag 14 securely during the inversion process. This is especially beneficial when dealing with the potential challenges of handling pet waste.

With continued reference to FIG. 2-FIG. 5, the exterior surface 34 of the paper material 32 that forms the bag body 18 may be coated with a protective barrier layer 38. Notably, the protective barrier 38 is shown in the figures with shading compared to the paper material 32, namely its interior surface 36 that is shown without shading. The protective barrier 38 will have an inner surface 40 and an outer surface 42. In one embodiment, the inner surface 40 of protective barrier layer 38 is applied directly to the exterior surface 34 of paper material 32. In one particular embodiment, the protective barrier layer 38 is composed of wax.

In one specific and particular embodiment of the present disclosure, the protective barrier layer 38 is only applied to the exterior surface 34 of the bag body 18. The exterior surface 34 refers to the outer surface of the bag prior to inversion of the bag after picking up the pet waste 16. The inner or interior surface 36 of the bag is left uncoated or untreated. Thus, when a user/pet owner 10 places their hand within the bag, they have a direct tactile interaction with the paper material 32 that forms the bag. This has been found to be advantageous as many people do not enjoy the feeling of wax (i.e., greasy) on their fingers or hand. Stated otherwise, in this particular embodiment, when there is wax on the exterior surface 34, there is no wax on the interior surface 36 of the pet waste bag body 18.

One advantage of not having wax on the interior surface 36 of the pet waste bag body 18 is that it provides the user with a tactile feedback of touching paper, directly, rather than the user touching the wax layer 38, which clearly imparts a waxy or greasy feeling to the user's touch. Further, the paper that forms the bag body 18 has an increased user-apparent gripability than the wax layer 38.

Although the preferred embodiment provides the barrier layer 38 only on the exterior surface 34 of the bag body 18, it is entirely possible for another embodiment of the present disclosure to have the material, such as wax, that forms the barrier layer on both the exterior surface 34 and the interior surface 36 of the bag body 18. Thus, an entirely coated bag body 18 does not depart from the scope of the present disclosure.

There are several types of wax that can be used to form the protective barrier layer 38 and be applied to the exterior surface 34 of a paper material 32 defining the pet waste container 14 to enhance its protective properties and create a barrier against moisture. Each type of wax has unique characteristics, and the choice depends on factors such as cost, environmental impact, and specific functional requirements. The following are exemplary types of wax that can be used. Beeswax is a natural and eco-friendly alternative to petroleum-based waxes. It is derived from honeybees and has inherent water-repelling properties. Beeswax is known for its pleasant scent and is biodegradable, making it a more environmentally conscious choice for pet waste bags. However, it can be more expensive than synthetic options. Soy wax is another environmentally friendly option that is derived from soybeans. It is biodegradable and renewable, making it a sustainable choice. Soy wax has good water resistance and adhesion properties, creating a protective layer on the paper bag. It is often used as an eco-conscious alternative to traditional waxes. Carnauba wax is derived from the leaves of the Brazilian carnauba palm tree. It is a hard and durable wax that provides excellent water resistance. Carnauba wax is often used in combination with other waxes to create a well-balanced coating with enhanced protective qualities. It is a natural and renewable resource.

When selecting the type of wax for a paper pet waste bag or container 14, considerations should be made regarding the bag's intended use, cost constraints, environmental impact, and user preferences. Regardless of the choice, the application of wax enhances the paper bag's functionality, providing the protective barrier 38 against moisture and contributing to a more effective and user-friendly pet waste management solution.

When gusseted features are combined with a wax-coated exterior surface, the result is a well-rounded and user-friendly pet waste bag or container 14. The wax-coated paper remains flexible and resistant to moisture, while the gusseted design accommodates varying waste volumes and ensures the bag retains its shape and stability during and after use. Namely, either gusseted sidewalls (i.e., first side panel 24 and second side panel 26), a gusseted bottom (i.e., bottom panel 28), or both in a paper pet waste bag body 18 create a synergy that enhances the bag's overall performance, especially when combined with a wax coating on the exterior. These design features contribute to increased volume, improved stability, and ease of use during the waste 16 collection and inversion processes.

In another exemplary embodiment, either the exterior surface 34 or the interior surface 36 of the bag body 18 could be textured. The exterior surface 34 or interior surface 36 texture of a paper bag coated with wax could be advantageous in providing gripability during the process of picking up pet waste 16 while still maintaining a protective layer of wax. Different textures can enhance the user experience, making the bag easier to handle, especially in outdoor environments. For example, the exterior surface 34 of the bag could have embossed patterns. Embossed patterns involve raised designs or textures on the surface of the paper bag. These can be strategically placed to create areas of increased friction, enhancing gripability. Common patterns include geometric shapes, ridges, or even paw prints. During inversion, the embossed patterns should be designed to minimize interference with the smooth motion required to turn the bag inside out. In another example, the exterior surface 34 or interior surface 36 could have microtexture. Microtextures are composed of tiny raised elements on the surface, providing a subtle but effective increase in friction. These textures are generally smaller and more uniform, offering a tactile feel without compromising the overall smoothness of the bag's exterior. During inversion, microtextures should be designed to be flexible enough not to impede the folding process. In another example, the exterior surface 34 or interior surface 36 could have a sanded finish. A sanded finish involves lightly abrading the surface of the paper, creating a slightly rough texture. This texture enhances gripability without being overly abrasive. During inversion, the sanded finish should remain pliable, ensuring that the paper can fold smoothly without resistance. In another example, the exterior surface 34 or interior surface 36 could have a matte finish. A matte finish provides a non-reflective surface that can offer improved gripability without the need for additional textures. The matte surface diffuses light, reducing slipperiness. During inversion, the matte finish should remain flexible to avoid hindering the folding process. In another example, the exterior surface 34 or interior surface 36 could have a textured coating. Coatings with embedded textures, such as fine particles or fibers, can be applied to the waxed surface. These coatings enhance grip without altering the overall appearance of the bag. During inversion, the embedded textures should not interfere with the folding or turning inside out.

In another exemplary embodiment, the bag body 18 may incorporate biodegradable reinforcement or webbings to enhance the bag's strength and durability, especially during the inversion process. By utilizing materials like twine or other natural fibers, pet owners can benefit from reinforced bags that remain entirely biodegradable, aligning with eco-friendly principles. For example, twine made from natural fibers such as jute, hemp, or cotton may be suitable as these materials are plant-based and break down naturally over time, ensuring that the entire bag remains environmentally friendly. The biodegradable reinforcement can be integrated into the paper material 32 during the manufacturing process. This could involve embedding strips of twine or natural fibers into the paper layer(s) as they are formed. The fibers add strength to the paper, enhancing its tear resistance without compromising its biodegradability. Alternatively, the twine or natural fibers can be applied to the surface of the paper bag. This can be achieved by adhering the fibers onto the exterior of the bag during or after the bag-making process. The fibers can be strategically placed to reinforce stress points, such as the bottom of the bag. After integrating or applying the biodegradable reinforcement, the exterior surface of the bag, including the natural fibers, can be coated with the layer of wax. The wax provides the protective barrier 38 against moisture, ensuring that the bag remains resistant to water and pet waste. This coating should cover the embedded or applied fibers, helping to maintain their integrity. The placement of the biodegradable reinforcement should be strategic, focusing on areas prone to stress or potential tearing during use. Common stress points include the bag's, the bottom, and the edges. Reinforcing these areas helps distribute the load more effectively, reducing the risk of ripping or tearing.

The flexibility of the reinforced areas should be considered, especially during the inversion process. The selected biodegradable reinforcement should be flexible enough to allow the bag to be easily turned inside out without causing resistance or hindrance. This flexibility is advantageous to maintaining the bag's user-friendly characteristics.

In one exemplary embodiment, the pet waste bags may be provided on a roll as a convenient and practical solution for pet owners, allowing for easy dispensing and portability during walks. This roll format ensures that users can tear away individual bags as needed, promoting efficient waste management while on the go.

Having thus described some exemplary configurations of a pet waste bag according to aspects of the present disclosure, reference is now made to exemplary operational embodiments shown in FIG. 6A-FIG. 6C. Notably, while the description of the operation of the bag is primarily described with reference to bag 14, it is to be understood that the same process applies to the other bags shown herein (i.e., bag 114, bag 214, bag 314, bag 414, and bag 514) yet these operational steps are not repeated for brevity.

It is known that pet waste management is an aspect of responsible pet ownership, and utilizing a bag to pick up a pet's waste (e.g., dog poop) is a common, respectful, and environmentally friendly practice. When the pet 12 is a dog, before embarking on a walk with the pet 12, the pet owner 10 should be prepared and carry at least one pet waste bag or container 14.

Once the pet 12 has completed its biological functions and created/generated pet waste or excrement 16, as the pet owner 10 prepares to pick up the pet's waste 16, the pet owner shall select a bag, such as bag 14. The bag may be from a roll or a singularly carried bag. When on a roll, the pet waste bags are conveniently perforated for easy separation. Once the pet owner has a bag in hand, the pet owner 10 should inspect it. The bag or container 14 comes equipped with the opening 30 for easy access and a closed end (i.e., bottom panel 28).

While the use of disposable gloves is optional, it can be useful. Gloves provide an extra layer of protection, especially if the pet owner is sensitive to contact with pet waste 16 or if the pet owner is dealing with waste in an unfamiliar environment.

With the bag selected and opened, the next step is for the pet owner 10 to insert their hand 44 into the bag, much like donning a glove. The pet owner 10 shall ensure that their hand 44 is fully covered by the bag body 18, providing a barrier between the pet owner's skin and the pet waste 16. The pet owner should approach the waste 16, as indicated by Arrow A (see FIG. 6A), with care, and using the bag-covered hand, pick up the waste thoroughly, as indicated by Arrow B (see FIG. 6B). This step is advantageous not only for cleanliness but also for ensuring that you capture all the waste efficiently.

FIG. 6B depicts the process of inverting the bag after picking up the pet's waste 16, which serves not only to securely encase the waste within the bag or container 14 but also contributes significantly to maintaining hygiene and preventing accidental spills or leaks during the subsequent steps of disposal. More particularly, upon successfully picking up the pet's waste 16 using the bag-covered hand 44, the next action is to invert the bag, essentially turning it inside out. This maneuver is more than just a procedural formality; it plays a role in containing and isolating the waste, ensuring a seamless transition to the closure and disposal phases of the process.

The inversion process begins with a controlled movement, pulling the bag downward and over the hand that grasped the pet waste, as indicated by Arrows C. This motion, when executed properly, results in the bag body 18 turning inside out, encapsulating the waste 16 within its now-reversed interior. The primary purpose of this inversion is to confine the waste securely within the bag, preventing any direct contact between the waste and the external environment.

One feature of inverting the bag or container 14 is its ability to create a protective barrier 38. By turning the bag inside out, the exterior surface 34 coated with wax or another protective barrier 38 that was in direct contact with the pet waste 16 becomes the inner surface of the bag body 18, effectively isolating any residue or remnants within the bag or container 14. This containment is beneficial, especially if pet owner 10 is in a public space or an area where other people or animals may come into contact with the exterior of the bag or container 14. This protective function is beneficial for several reasons, centering on cleanliness, hygiene, and the general aversion to touching pet excrement 16. Firstly, cleanliness is a paramount concern in pet waste management. By inverting the bag or container 14, the exterior surface 34 and barrier layer 38 that came into contact with the pet waste 16 becomes the inner surface of the now-inverted bag, thereby isolating any residue or remnants within the bag. This containment is not merely about preventing external surfaces from getting soiled; it actively contributes to maintaining a clean and hygienic environment, especially in public spaces where others may come into contact with the exterior of the bag. Secondly, the protective barrier created by the inverted bag is assists in preventing the spread of germs and bacteria. Pet waste, like any other form of fecal matter, can harbor harmful microorganisms that pose health risks. The inversion process ensures that any potential contaminants are confined within the bag, minimizing the risk of transferring germs to surfaces, hands, or other objects. This containment is particularly relevant in areas frequented by people and other animals, where the transmission of germs can have broader health implications. Thirdly, the protective barrier addresses the general aversion to touching pet excrement, a sentiment shared by many pet owners. The act of picking up pet waste is a responsibility that pet owners willingly undertake, but the inherent aversion to direct contact with fecal matter is a natural human response. Inverting the bag provides a psychological buffer, allowing pet owners to fulfill their duty without the need for direct tactile interaction with the waste. This not only enhances the overall experience of pet waste management but also encourages more individuals to adhere to responsible waste disposal practices.

The protective nature of the inverted bag also plays a role in minimizing odor exposure. Pet waste can emit unpleasant odors, and the inversion process helps trap these odors within the bag. This containment is essential not only for the pet owner's comfort during the remainder of the walk but also for the consideration of others in shared public spaces. By keeping odors confined within the inverted bag, the overall environment remains more pleasant and respectful to those sharing the area.

Additionally, the protective barrier 38 created by bag inversion aligns with broader principles of waste management. It reinforces the notion that pet waste is not merely discarded casually but is treated as a potentially hazardous material that requires containment and responsible disposal. This mindset promotes a cleaner and safer environment for everyone, addressing both individual concerns about cleanliness and the collective goal of maintaining public spaces.

Introducing the protective barrier layer 38 of wax to the exterior surface 34 of a paper pet waste bag adds an extra dimension to the concept of a protective barrier during the inversion process. This innovation enhances the containment of pet waste, addressing cleanliness, hygiene, and the aversion to touching pet excrement.

The inclusion of a wax or protective barrier layer 38 on the exterior surface 34 of the paper bag serves as a practical solution to the potential permeability of paper. While paper is absorbent and may have a porous nature, the wax barrier layer 38 provides an impermeable and water-resistant barrier. This exterior wax or barrier layer acts as a shield against moisture, ensuring that any liquid components from the pet waste are contained within the bag, preventing leakage and maintaining the bag's structural integrity during the inversion process.

As the pet owner picks up the waste using the wax-coated exterior surface 34 of the bag, the protective barrier is immediately activated. The wax layer acts as a first line of defense, preventing direct contact between the paper bag and the pet waste. This is particularly beneficial in situations where the waste may be more liquid or moist, ensuring that the bag remains an effective containment vessel.

During the inversion process, the wax-coated exterior becomes the interior surface of the bag. This transition is seamless and preserves the protective qualities of the wax layer. The inverted bag, with its now-waxed interior, continues to provide a robust barrier against any residual moisture or germs, effectively isolating the pet waste within.

Further, the addition of wax to the exterior surface also contributes to minimizing odor exposure. The impermeability of the wax prevents the absorption of odors into the paper fibers, keeping any unpleasant smells associated with pet waste confined within the bag. This feature is particularly advantageous in crowded public spaces where minimizing odor is essential for maintaining a pleasant environment.

Furthermore, the wax-coated paper bag, with its protective barrier properties, aligns with eco-friendly considerations. While plastic bags may provide similar impermeability, the waxed paper bag offers a more environmentally conscious alternative. The biodegradability of paper, coupled with the impermeable wax layer, presents a sustainable option for pet waste management.

The tactile experience for the pet owner is also enhanced by the wax-coated paper bag. The smooth surface of the waxed exterior makes the bag more user-friendly, reducing the tactile discomfort often associated with handling paper bags. This can be especially appealing to pet owners who may have an aversion to touching pet waste directly.

Thus, operationally, incorporating a protective barrier layer 38 of wax onto the exterior surface of a paper pet waste bag elevates the concept of a protective barrier during the inversion process. This innovation addresses concerns related to cleanliness, hygiene, and the aversion to touching pet excrement by providing an impermeable shield against moisture, enhancing odor containment, and offering a more user-friendly and environmentally conscious solution. As pet owners increasingly prioritize responsible waste management, such innovative approaches contribute to creating a more pleasant and sustainable environment for both pet owners and the community at large.

FIG. 6C depicts that once the inversion is complete, and the pet owner has doffed the bag, the pet owner 10 can secure the bag with a twist-knot or twisted-closure 46. A well-executed inversion and doffing ensures that the top opening 30 of the bag is easily accessible for tying or twisting the top, thereby making the closure step more efficient and reliable. A secure twist-knot or twisted-closure 46 at the bag's top opening is beneficial for containing odors and preventing any potential escape of waste 16 during transportation to a disposal site. The wax layer on the now-inverted interior of the bag assists to seal top opening 30 of the bag when it is twisted close. The seal imparted by the wax layer assist to retain the pet waste, along with its odors, within the bag. Alternatively, in lieu of a twist closure or twist knot, the pet owner may tie a knot or seal the top with some other tie device.

With the waste securely sealed in the bag, as shown in FIG. 6C, the pet owner should find an appropriate disposal location. Responsible disposal options include dedicated pet waste bins or regular trash bins. Many public areas and parks have designated receptacles for pet waste. Ensure that the disposal bin is easily accessible, and drop the securely tied bag into it. This step is beneficial in maintaining cleanliness in public spaces and contributing to a positive community environment.

Whether or not disposable gloves were used, the pet owner should practice good hygiene after handling pet waste. The pet owner should consider carrying a small bottle of hand sanitizer. If the pet owner didn't use gloves, then the hands should be washed thoroughly with soap and water. This step not only removes any residual germs but also promotes overall cleanliness.

Beyond the immediate hygiene considerations, using a bag to pick up pet waste is a practice rooted in environmental responsibility. Pet waste, if left unattended, can have detrimental effects on the environment. The feces contain bacteria and parasites that can contaminate soil and water, posing risks to both human and animal health. By using a bag to pick up and dispose of pet waste properly, pet owners actively contribute to the well-being of the environment.

While the pet waste bag body 18 or container 14 is commonly associated with dog owners during walks, they can be useful for various other pets and animals that require waste management. As such, the bags provide a practical solution for maintaining cleanliness and hygiene across a broad spectrum of pets and situations, contributing to responsible waste management practices.

For example, the pet waste bag or container 14 of the present disclosure may be used by cat owners for cleaning litter boxes. Scooping and disposing of cat litter waste become more convenient with the use of these bags. This ensures a hygienic and mess-free process for maintaining a cat's litter area. Further, owners of small rodents (e.g., hamsters, mice, gerbils) may use the pet waste bag when cleaning their pets' cages or enclosures. The bags are practical for disposing of bedding, droppings, and any other waste material generated by these animals. Further, bird owners, particularly those with larger pet birds, may use the waste bag when cleaning cages or aviaries. This helps in efficiently managing bird droppings and maintaining a clean living space for the avian pets. Still further, owners of reptiles, such as snakes or lizards, can use pet waste bags for cleaning terrariums or cages. This is especially relevant when removing substrate or waste from the enclosure to maintain a clean and healthy environment for the reptile. Still further, the pet waste bags are beneficial for owners of small mammals (e.g., Rabbits, Guinea Pigs) when cleaning cages or hutches. Whether it's removing soiled bedding or handling waste from litter boxes, these bags offer a convenient solution for disposal. Further, while fish themselves do not produce waste that requires bagging, aquarium owners may find pet waste bags useful for cleaning and disposing of filter media or other materials used in aquarium maintenance given the wax layer's ability to repel water. Still on farms, waste bags can be utilized for cleaning up after small animals such as goats, sheep, or chickens. This can be particularly relevant in areas where waste needs to be collected for proper disposal or composting with biodegradable materials. Still further, owners of exotic pets, including those with unconventional animals such as hedgehogs, sugar gliders, or ferrets, may find pet waste bags practical for managing waste during play or handling.

Additionally, while the pet waste bag or container 14 shown herein has a bag-like shape there are several alternative shapes and configurations that could be explored to pick up pet excrement. For example, the paper and waxed outer surface could be designed in the form of a glove or mitten, allowing the user to wear it on their hand. This design provides a hands-on and direct approach to picking up pet waste. It might have an opening for the hand and a wider section for waste collection, mimicking the ease of using a glove. Further alternatively, a scoop-shaped design could be considered, resembling a small shovel or ladle. This shape is practical for collecting solid waste without the need for direct contact with the hands. The scoop could have a handle for easy use and disposal. Still further, an envelope or pouch-shaped bag could feature a wider opening for waste collection that tapers down to a sealed end. This design allows for easy and secure closure, similar to sealing an envelope, ensuring containment of the waste. Additionally, a container with a funnel shape could be provided, where the wider end serves as the opening for waste collection, and the narrow end facilitates easy tying and sealing. This shape provides a targeted collection point for waste. Still further, a bag shaped like a claw or tongs could be designed, featuring a gripping mechanism at one end for picking up waste. This shape provides a hands-free option for waste collection and disposal.

Having thus described an exemplary embodiment of a pet waste bag, such as bag 14, and its inversion process for assisting in the collection of pet waste, reference is now made to other embodiments of the present disclosure that have different structural configurations of various bag shapes but would function in a similar manner being used in a similar inversion process to collect or pick up pet waste as described above with respect to FIGS. 6A-6C.

FIG. 7 depicts an example of another exemplary pet waste bag or pet waste container 114. Bag 114 has a paper bag body 118. The first side 124 has a gusset fold 125 and the second side 126 has a gusset fold 127 similar to bag body 18. However in this embodiment, there is an open top and a non-gusseted enclosed bottom 128. The non-gusseted bottom 128 is created by the front panel being non-expandable connected to the rear panel of the bag body 118. The sides 124, 126 extend parallel to each other, straight down from the top to the bottom 128 of bag body 118. The bag 114 is configured for the unique application of grasping pet waste and then inverting the bag in the manner described above in FIGS. 6A-6C with the understanding the that the reference numerals would apply mutatis mutandis for the description of the inversion of bag 114.

FIG. 8 depicts another exemplary embodiment of a pet waste bag or pet waste container 214. Bag 214 has a paper bag body 218. The first side 224 has a gusset fold 225 and the second side 226 has a gusset fold 227 similar to bag body 18. However in this embodiment, there is an open top and a non-gusseted enclosed bottom 228. The non-gusseted bottom 228 is created by the front panel being non-expandable connected to the rear panel of the bag body 218. The sides 124, 126 taper from the top to the bottom 228 of bag body 218. As such, the top opening of the bag body 218 is wider than the bottom 228. Having a tapered container 214 may assist with the inversion process as previously described. The bag 214 is configured for the unique application of grasping pet waste and then inverting the bag in the manner described above in FIGS. 6A-6C with the understanding the that the reference numerals would apply mutatis mutandis for the description of the inversion of bag 214.

FIG. 9A and FIG. 9B depict another exemplary embodiment of a pet waste bag or pet waste container 314. FIG. 9A and FIG. 9B depict that the pet waste bag 314 may be shaped as a bag. When the bag 314 is shaped like a bag, there is a bag body 318 which may have a first panel 320 and a second panel 322. There may be a first side panel 324, a second side panel 326, and a bottom edge 327. The bag body 318 defines a top opening 330 and has an enclosed bottom end because of bottom edge 327. This embodiment shows that the first side panel 324 and the second side panel 326 are gusseted, although it is not necessarily required.

Incorporating the gusseted sidewalls (e.g. first side panel 324 or second side panel 326) into a paper pet waste bag body 318 coated with a protective barrier 38 on the exterior surface can enhance the bag's functionality, especially during the inversion process, which has previously been described herein. These design features provide added flexibility, strength, and convenience, making it easier for pet owners to manage and invert the bag after picking up their pet's waste.

Utilizing gusseted sidewalls synergistically enhances the overall design of the pet waste bag 314. The combined effect provides not only increased volume but also ease of use during waste collection and inversion. The gusseted bottom ensures the bag maintains its shape, while the gusseted sidewalls contribute to the bag's flexibility and capacity.

Further, although the FIG. 9A and FIG. 9B show a single crease or edge defining the gusset on each side, it is possible for there to be multiple gusseted walls. This would result in a bag with an accordion or concertina shape, where the sides of the bag can expand and contract, based on multiple folds. This design would also provide flexibility in adjusting the bag size based on the amount of waste being collected.

The size parameters of an exemplary pet waste bag 314 depend on various factors, including the intended use, the size of the pets, and user preferences. In one exemplary embodiment, the pet waste bag 314 should be of sufficient size to comfortably accommodate the waste 16 produced by different sizes of pets 12. Common dimensions for a pet waste bag body 318, when laid flat, have a width (side-to-side), as shown by dimension 333, that is in a range from about 6 inches to about 18 inches, and a length (top-to-bottom), as shown by dimension 335, that is in a range from about 6 inches to about 24 inches. In one exemplary embodiment, dimension 333 and dimension 335 are equal. In one particular embodiment, the dimensions 333, 335 of the bag, when laid flat, are both about 9 inches. This should provide enough space for waste collection without being overly large or cumbersome.

The preferred volume defined by the interior space 331 that is in open communication with the top opening 330 of a pet waste bag 314 is advantageous to ensure ease of use and practicality during the inversion process. A well-designed bag should offer sufficient volume, defined by interior space 331, to accommodate various amounts of pet waste while also providing an opening large enough for the user's hand to perform the inversion comfortably. A suitable volume defined by interior space 331 allows for the effective containment of pet waste, catering to the variability in waste quantities produced by different pets. Generally, the pet waste bag with a volume ranging from 0.5 to 4.5 liters is considered practical for everyday use. For example, the bag should be sized to accommodate the amount of waste that the pet produces. For example, it is common for large dogs to produce large amounts of excrement, and the size or volume of the bag should account for that amount of waste. However, the bag could be manufactured in a smaller size if configured for use with a smaller dog or other pet.

As stated previously, some embodiments of the present disclosure have gussets that allow the bag to expand and provide additional volume, making it more versatile for various waste quantities. A typical gusset depth 337 might range from 0.5 inch to 4 inches, allowing the bag to expand when needed while maintaining strength and tear resistance.

The top opening 330 of the bag should be designed to accommodate the user's hand comfortably during the inversion process. A typical dimension for the top opening is around 6 to 18 inches (about 15 to 45 centimeters) in width. In the shown embodiment, the width of the top opening 330 is the same as dimension 333, which is about 9 inches. This width ensures that users can easily reach into the bag to pick up pet waste without struggling with a narrow or restrictive opening. The dimensions of the top opening 330 should prioritize user comfort and dexterity. A wider opening allows for easy access, making it simpler for users to perform the inversion process and twist knots securely after collecting pet waste. The design should be intuitive, ensuring a seamless experience for pet owners 10 of all ages. For pet owners 10 with larger breeds that produce more substantial waste 16, a slightly larger volume and larger top opening may be beneficial. This ensures that the bag remains practical and effective for users with pets of varying sizes.

The bag's dimensions, volume and shape should contribute to the overall ease of the inversion process. Users should be able to turn the bag inside out effortlessly (e.g., invert), allowing for quick and efficient disposal of pet waste. The design should minimize any resistance or difficulty in performing this task.

Bag 314 may have a curved top edge 339 that extends from a first end 341 to a second end 343. The first end 341 meets a straight edge 345 that is coextensive with the first side panel 324 and extends downward to the bottom edge 327. The second end 343 meets a straight edge 347 that is coextensive with the second side panel 326 and extends downward to the bottom edge 327. The curved top edge 339 has a radius of curvature 349 extending from the center 351 to the edge 339. In an exemplary embodiment, the radius of curvature is in a range from about 3 inches to about 6 inches. In one particular embodiment, the radius of curvature 349 is about 4.5 inches. When the overall length dimension 335 is 9 inches and the radius of curvature 349 is 4.5 inches, then the length of the straight edges 345, 347 is also 4.5 inches. There is an apex in the top edge 339 that is curved, wherein the apex is centered relative to a width dimension 333 of the bag body 318.

In one embodiment, the curved top edge 339 may be established by die cutting a rectangular bag. When the bag is die cut to define the curved top edge, this die cutting action would result in upwardly extending wings or ears in each of the side panels 324, 326. For example, as shown in FIG. 9B, a first upwardly extending ear 353 is defined in first side panel 324 and a second upwardly extending ear 355 is defined in second side panel 326. Each ear 353, 355 may have an apex that is coextensive with the fold of the gusset. Further, the curvature of the outer edge of the ear would be same as the radius of curvature 349 of the top edge 339 due to the die cut performed on the bag.

In one embodiment, the dimension and configuration of the bag body 318 has unique advantages that are not matters of design choice. Additionally, there may be some criticality to the claimed ranges of the dimensions of bag body 318. For example, the bag 314 is configured for the unique application of grasping pet waste and then inverting the bag in the manner described above in FIGS. 6A-6C with the understanding the that the reference numerals would apply mutatis mutandis for the description of the inversion of bag 314. The identified ranges of dimensions, as well as the curved top edge assist in the inversion process by reducing the likelihood of paper material 32 that forms the bag body 318 from ripping or tearing.

FIG. 10A and FIG. 10B depict another exemplary embodiment of a pet waste bag or pet waste container 414. FIG. 10A and FIG. 10B depict that the pet waste bag 414 may be shaped as a bag. When the bag 414 is shaped like a bag, there is a bag body 418 which may have a first panel 420 and a second panel 422. There may be a first side panel 424, a second side panel 426, and a bottom edge 427. The bag body 418 defines a top opening 430 and has an enclosed bottom end because of bottom edge 427. This embodiment shows that the first side panel 424 and the second side panel 426 are gusseted, although it is not necessarily required.

Incorporating the gusseted sidewalls (e.g. first side panel 424 or second side panel 426) into a paper pet waste bag body 418 coated with a protective barrier 38 on the exterior surface can enhance the bag's functionality, especially during the inversion process, which has previously been described herein. These design features provide added flexibility, strength, and convenience, making it easier for pet owners to manage and invert the bag after picking up their pet's waste.

Utilizing gusseted sidewalls synergistically enhances the overall design of the pet waste bag 414. The combined effect provides not only increased volume but also ease of use during waste collection and inversion. The gusseted bottom ensures the bag maintains its shape, while the gusseted sidewalls contribute to the bag's flexibility and capacity.

Further, although the FIG. 10A and FIG. 10B show a single crease or edge defining the gusset on each side, it is possible for there to be multiple gusseted walls. This would result in a bag with an accordion or concertina shape, where the sides of the bag can expand and contract, based on multiple folds. This design would also provide flexibility in adjusting the bag size based on the amount of waste being collected.

The size parameters of an exemplary pet waste bag 414 depend on various factors, including the intended use, the size of the pets, and user preferences. In one exemplary embodiment, the pet waste bag 414 should be of sufficient size to comfortably accommodate the waste 16 produced by different sizes of pets 12. Common dimensions for a pet waste bag body 418, when laid flat, have a width (side-to-side), as shown by dimension 433, that is in a range from about 6 inches to about 18 inches, and a length (top-to-bottom), as shown by dimension 435, that is in a range from about 6 inches to about 24 inches. In one exemplary embodiment, dimension 433 and dimension 435 are equal. In one particular embodiment, the dimensions 433, 435 of the bag, when laid flat, are both about 9.25 inches. This should provide enough space for waste collection without being overly large or cumbersome.

The preferred volume defined by the interior space 431 that is in open communication with the top opening 430 of a pet waste bag 414 is advantageous to ensure ease of use and practicality during the inversion process. A well-designed bag should offer sufficient volume, defined by interior space 431, to accommodate various amounts of pet waste while also providing an opening large enough for the user's hand to perform the inversion comfortably. A suitable volume defined by interior space 431 allows for the effective containment of pet waste, catering to the variability in waste quantities produced by different pets. Generally, the pet waste bag with a volume ranging from 0.5 to 4.5 liters is considered practical for everyday use. For example, the bag should be sized to accommodate the amount of waste that the pet produces. For example, it is common for large dogs to produce large amounts of excrement, and the size or volume of the bag should account for that amount of waste. However, the bag could be manufactured in a smaller size if configured for use with a smaller dog or other pet.

As stated previously, some embodiments of the present disclosure have gussets that allow the bag to expand and provide additional volume, making it more versatile for various waste quantities. A typical gusset depth 437 might range from 0.5 inch to 4 inches, allowing the bag to expand when needed while maintaining strength and tear resistance.

The top opening 430 of the bag 414 should be designed to accommodate the user's hand comfortably during the inversion process. A typical dimension for the top opening is around 6 to 18 inches (about 15 to 45 centimeters) in width. In the shown embodiment, the width of the top opening 430 is about 9.25 inches and the length dimension 435 is about 9.375 inches. However, as with other embodiments, dimension 433 and 435 could be the same. This width ensures that users can easily reach into the bag to pick up pet waste without struggling with a narrow or restrictive opening. The dimensions of the top opening 430 should prioritize user comfort and dexterity. A wider opening allows for easy access, making it simpler for users to perform the inversion process and twist knots securely after collecting pet waste. The design should be intuitive, ensuring a seamless experience for pet owners 10 of all ages. For pet owners 10 with larger breeds that produce more substantial waste 16, a slightly larger volume and larger top opening may be beneficial. This ensures that the bag remains practical and effective for users with pets of varying sizes.

The bag's dimensions, volume and shape should contribute to the overall ease of the inversion process. Users should be able to turn the bag inside out effortlessly (e.g., invert), allowing for quick and efficient disposal of pet waste. The design should minimize any resistance or difficulty in performing this task.

Bag 414 may have a curved top edge 439 that extends from a first end 441 to a second end 443. The first end 441 meets a straight edge 445 that is coextensive with the first side panel 424 and extends downward to the bottom edge 427. The second end 443 meets a straight edge 447 that is coextensive with the second side panel 426 and extends downward to the bottom edge 427. The curved top edge 439 has a primary radius of curvature (R1) 449 of a central major portion of the top edge 439, wherein the primary radius of curvature (R1) 449 is measured from the center 451 of the central major portion. The radius of curvature (R1) 449 is in a range from about 3 inches to about 6 inches. In the shown example, the radius of curvature (R1) 449 is 4 inches. There is an apex in the top edge 439 that is curved, wherein the apex is centered relative to a width dimension 433 of the bag body 418. At each side-end of the central major portion a minor curvature. For example, there is a minor first curvature 457 at the first end 441 of the top edge 439, wherein the minor first curvature 457 is curved oppositely than the top edge 439 and a minor second curvature 459 at the second end 443 of the top edge 439, wherein the minor second curvature 459 is curved oppositely than the top edge 439. For example, the central major portion is convexly curved while the minor curvatures are concavely curved. Each minor curvature 457, 459 has a minor second radius of curvature (R2) 461. The minor second radius of curvature (R2) 461 is in a range from about 0.25 inch to about 1 inch. In the shown example, the minor second radius of curvature (R2) 461 is 0.625 inch. When the overall length dimension 435 is 9.375 inches and the radius of curvature (R1) 449 is 4 inches and the minor curvature (R2) is 0.625 inch, then the length of the straight edges 345, 347 is about 4.75 inches.

A ratio can be established based on R1 to R2. Depending on the configuration of bag 414 the ratio of R1 to R2 is in a range from about 4:0.5 to about 12:0.5. In the shown embodiment, with the dimension detailed above, when R1 is 4 inches and R2 is ⅝ inch (0.625 inch), and the ratio of R1 to R2 is 4:0.625.

In one embodiment, the curved top edge 439 may be established by die cutting a rectangular bag. When the bag is die cut to define the curved top edge, this die cutting action would result in upwardly extending wings or ears in each of the side panels 424, 426. For example, as shown in FIG. 10B, a first upwardly extending ear 453 is defined in first side panel 324 and a second upwardly extending ear 455 is defined in second side panel 426. Each ear 453, 455 may have an apex that is coextensive with the fold of the gusset. Further, the curvature of the outer edge of the ear would be same as the radius of curvature 449 of the top edge 439 and the lower ends of the ears 453, 455 would have minor curvatures similar to minor radius of curvature 461 due to the die cut performed on the bag 414.

In one embodiment, the dimension and configuration of the bag body 418 has unique advantages that are not matters of design choice. Additionally, there may be some criticality to the claimed ranges of the dimensions of bag body 318. For example, the bag 414 is configured for the unique application of grasping pet waste and then inverting the bag in the manner described above in FIGS. 6A-6C with the understanding the that the reference numerals would apply mutatis mutandis for the description of the inversion of bag 414. The identified ranges of dimensions, as well as the curved top edge 439 and the minor curves 457, 459 assist in the inversion process by reducing the likelihood of paper material 32 that forms the bag body 418 from ripping or tearing. The shape of this bag 414 will allow the pet owner to pull the top edge of the bag body 418. During inversion, the pet owner will pass the top edge 439, which may be pulled at the apex, by either or both upwardly extending ears 453, 455 defined in a side panel of the bag body as the top edge is pulled toward the bottom enclosed bottom. This would bend the first minor curvature 457 located at a first end of the top edge 439 and bend the second minor curvature 459 located at a second end of the top edge 439 in response to pulling the top edge.

FIG. 11A and FIG. 11B depicts another exemplary embodiment of a pet waste bag or pet waste container 514. Bag 514 has a paper bag body 518. The first side 524 has a gusset fold 525 and the second side 526 has a gusset fold 527 similar to bag body 18. However in this embodiment, there is an open top and gusseted enclosed bottom 528. The sides 524, 526 taper from the top to the bottom 528 of bag body 518 at and angle 529 that is about 25° from horizontal. As such, the top opening of the bag body 518 is wider than the bottom 528. The width dimension 533 of the bottom 528 may be about 5 inches. The height dimension 535 from the bottom 528 to the edge of the top opening is about 4.5 inches. Having a tapered container 214 may assist with the inversion process as previously described. The bag 514 has the same protective barrier 38 on the exterior surface of the bag (e.g., prior to inversion) is configured for the unique application of grasping pet waste and then inverting the bag in the manner described above in FIGS. 6A-6C with the understanding the that the reference numerals would apply mutatis mutandis for the description of the inversion of bag 514.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the bag being generally rectangular in shape, the bag can be semi-circular, triangular, square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meaning.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A disposable pet waste container comprising:
a bag body formed of paper, the bag body having a first side opposite a second side, and an open top opposite an enclosed bottom;
an exterior surface of the bag body and an interior surface of the bag body, wherein the interior surface defines a volume sized to accommodate a pet owner hand through the open top; and
a protective barrier on the exterior surface of the bag body;
wherein the bag body is configured to be inverted in response to the pet owner grasping pet waste with the bag body, wherein the protective barrier directly contacts the pet waste during grasping of pet waste, wherein after inversion the protective barrier is on the inside of the inverted bag.

2. The disposable pet waste container of claim 1, wherein the protective barrier is applied only to the exterior surface and not to the interior surface prior to inversion, wherein the protective barrier is biodegradable wax and defines a wax layer only on the exterior surface of the bag body.

3. The disposable pet waste container of claim 1, wherein the first side of the bag body has a gusset and wherein the second side of the bag body has a gusset, and wherein the enclosed bottom of the bag body is non-gusseted.

4. The disposable pet waste container of claim 1, wherein the first side of the bag body has a first gusset, the second side of the bag body as a second gusset, and the enclosed bottom of the bag body as a third gusset.

5. The disposable pet waste container of claim 1, wherein the bag body is formed from kraft paper.

6. The disposable pet waste container of claim 1, wherein the open top is wider than the enclosed bottom such that the first side and the second side of the bag body taper from the open top to the enclosed bottom.

7. The disposable pet waste container of claim 1, wherein the bag body further comprises:
a top edge defining a portion of the open top of the bag body, wherein the top edge has a first end connected to the first side of the bag body and a second end connected to the second side of the bag body, wherein the top edge is curved between the first end and the second end.

8. The disposable pet waste container of claim 7, wherein the bag body further comprises:
an apex in the top edge that is curved, wherein the apex is centered relative to a width of the bag body.

9. The disposable pet waste container of claim 7, wherein the bag body further comprises:
a radius of curvature of the top edge that is curved, wherein the radius of curvature is in a range from about 3 inches to about 6 inches.

10. The disposable pet waste container of claim 7, wherein the bag body further comprises:
a minor first curvature at the first end of the top edge, wherein the minor first curvature is curved oppositely than the top edge; and
a minor second curvature at the second end of the top edge, wherein the minor second curvature is curved oppositely than the top edge.

11. The disposable pet waste container of claim 10, wherein the top edge is convexly curved, and wherein the minor first curvature and the minor second curvature are concavely curved.

12. The disposable pet waste container of claim 11, wherein the bag body further comprises:
a radius of curvature of a central major portion the top edge (R1);
a radius of curvature of the minor first curvature at the first end (R2); and
a ratio of R1 to R2, wherein the ratio is in a range from about 4:0.5 to about 12:0.5.

13. A method comprising:
donning a disposable pet waste container by reaching through an open top towards an enclosed bottom of a bag body formed of paper, and the bag body having an exterior surface coated with wax;
approaching pet waste with the donned disposable pet waste container;
contacting the wax with the pet waste;
grasping the pet waste;
picking up the pet waste while continuing to grasp the pet waste;
inverting the disposable pet waste container while continuing to grasp the pet waste;
doffing the disposable pet waste container after inversion to retain the pet waste in a now-reversed interior of the bag body; and
disposing the bag body containing the pet waste.

14. The method of claim 13, further comprising:
after doffing, twist closing the open top of the bag body.

15. The method of claim 13, wherein inverting the disposable pet waste container while continuing to grasp the pet waste is accomplished by grasping a top edge of the bag body with an opposite hand than that which is grasping the pet waste, further comprising:
pulling the top edge of the bag body toward the enclosed bottom of the bag body where the pet waste is grasped.

16. The method of claim 15, further comprising:
pulling the top edge of the bag body, wherein the top edge is curved; and
passing the top edge by an upwardly extending ear defined in a side panel of the bag body as the top edge is pulled toward the bottom enclosed bottom.

17. The method of claim 15, further comprising:
bending a first minor curvature located at a first end of the top edge and bending a second minor curvature located at a second end of the top edge in response to pulling the top edge.

18. The method of claim 15, wherein donning the disposable pet waste container comprises:
reaching though the open top and beyond a top edge of the bag body, wherein the top edge is curved at a central major portion of the top edge; and
reaching though the open top and beyond a first minor curvature located at a first end of the top edge and beyond a second minor curvature located at a second end of the top edge, wherein the first minor curvature and the second minor curvature are oppositely curved than the central major portion of the top edge.

19. The method of claim 13, wherein donning the disposable pet waste container comprises:
expanding a first side gusset of the bag body in response to reaching through the open top; and
expanding a second side gusset of the bag body in response to reaching through the open top.

20. The method of claim 13, wherein donning the disposable pet waste container comprises:
expanding a bottom gusset defining the enclosed bottom of the bag body in response to reaching through the open top.
